(19) United States
(12) Patent Application Publication
(10) Pub. No.: US 2018/0298764 A1
(43) Pub. Date: Oct. 18, 2018

(54) TURBINE BLADE HAVING A GROOVE IN THE CROWN BASE

(71) Applicant: Siemens Aktiengesellschaft, München (DE)

(72) Inventors: Fathi Ahmad, Kaarst (DE); Andreas Heselhaus, Düsseldorf (DE)

(73) Assignee: Siemens Aktiengesellschaft, Munich (DE)

(21) Appl. No.: 15/762,687

(22) PCT Filed: Aug. 30, 2016
(86) PCT No.: PCT/EP2016/070352

§ 371 Date: Mar. 23, 2018

(30) Foreign Application Priority Data
Sep. 28, 2015 (EP) 15187014.4

(51) Int. Cl. F01D 5/18; F01D 5/20

(52) U.S. Cl. CPC F01D 5/187; F01D 5/20; F05D 2220/32; F05D 2240/307; F05D 2260/20

(57) ABSTRACT

A turbine blade for a gas turbine, has a blade, with a blade wall and a crown base arranged at the free end of the blade. The blade wall surrounds at least a first and a second flow chamber, between which a first separating wall is arranged, wherein a free through-hole for connecting the first and the second flow chambers is present between the first separating wall and the crown base. Furthermore, at least one cooling air opening is present in the crown base. The cooling air opening is designed as a relief groove, which extends to a point over the through-hole at least in some sections.

### CROSS REFERENCE TO RELATED APPLICATIONS

This application is the US National Stage of International Application No. PCT/EP2016/070352 filed Aug. 30, 2016, and claims the benefit thereof. The International Application claims the benefit of European Application No. EP15187014 filed Sep. 28, 2015. All of the applications are incorporated by reference herein in their entirety.

### FIELD OF INVENTION

The invention relates to a turbine blade for use in a gas turbine, having a blade root and a blade airfoil, wherein a cooling-air opening is present in the crown base of the blade airfoil.

### BACKGROUND OF INVENTION

Turbine blades for use in a gas turbine are known in various embodiments, these generally having at least a blade root for the fastening in the respective turbine stage and a blade airfoil adjoining the blade root. In this case, the blade airfoil is aerodynamically formed, the specific shape not being of primary importance for the embodiment according to the invention. Here, the blade airfoil is first of all formed by a blade wall which extends from the blade root to a free end. There, the free end of the blade airfoil is generally closed off by means of a crown base.

Owing to the high temperatures occurring in a gas turbine, the turbine airfoil is furthermore cooled by means of cooling air in a known way. In this case, cooling-air ducts pass through the interior of the turbine blade. Known here are both embodiments, for example from EP 2 196 625 A1, in which the cooling air is guided back to the blade root and also embodiments in which cooling-air openings, via which the cooling air is able to escape, are arranged in the blade wall and in the crown base. Embodiments of the latter type are presented for example by GB 2 061 400, US 2002/119045 A1 and US 2005/281671 A1. Further known embodiments for a turbine blade with cooling ducts are disclosed by documents EP 1 557 553 A1 and EP 2 863 013 A1. For the targeted fixing of the cooling-air stream through the cooling-air openings at the blade airfoil, which openings are generally present in a plurality, said cooling-air openings are distributed in a corresponding, suitable way and are normally formed as circular bores. Furthermore, embodiments are also known in which the cooling-air openings open in a funnel-like manner.

Although advantageous cooling of the blade airfoil is already able to be brought about by way of the known embodiments, the problem arises however that zones of different temperatures form, and thus local thermal stresses occur, as a result of the blade airfoil cooling. These arise particularly in the crown base owing to the outer temperatures, which are high, and the inner temperatures, which are lower due to the cooling air, in the blade airfoil.

### SUMMARY OF INVENTION

It is therefore an object of the present invention to reduce thermal stresses owing to differing temperature distributions in the blade airfoil.

This object addressed is achieved by way of an embodiment according to the invention according to the teaching of the independent claim.

Advantageous embodiments constitute the subject matter of the subclaims.

A generic turbine blade serves first of all for use in a turbine of a gas turbine. In this case, the turbine blade has a blade root and a blade airfoil which adjoins the blade root. Here, the blade airfoil is aerodynamically curved, with the result that effective generation of rotation in the rotor of the gas turbine is able to be brought about by means of the turbine blade. The blade airfoil is first of all formed by a blade wall which extends from the blade root in the direction of a free end. The blade wall comprises a pressure-side wall section and a suction-side wall section, with both sections extending from a front edge (generally rounded) of the blade airfoil to a rear edge (generally tapering to a point) of the blade airfoil. Arranged at the free end of the blade airfoil is a crown base which substantially closes off the blade airfoil at the free end. With regard to the specific arrangement of the crown base at the free end of the blade airfoil, it is not of primary importance whether the crown base is arranged directly at the end of the blade wall and at the same time forms the free end of the blade airfoil, or whether the crown base is positioned so as to be set back in relation to the outer free end of the blade airfoil.

A cavity is formed by the blade wall with the two wall sections, the crown base and the blade root and surrounds at least one first and one second flow chamber. In this respect, it is unimportant whether further flow chambers are formed in the interior of the blade airfoil. It is at least the case that the first flow chamber is separated from the second flow chamber by a first separating wall. Here, both the first and second flow chambers, and also the first separating wall, likewise extend from the blade root in the direction of the free end of the blade airfoil. A free through-passage, which forms a connection between the first and second flow chambers such that the cooling air is able to flow from the second flow chamber into the first flow chamber through the through-passage, is present at that end of the first separating wall which points toward the crown base. Here, it is not of primary importance whether the through-passage extends over the entire width of the separating wall and thus upwardly delimits the latter, or has a width which is smaller in relation to the separating wall so that a piece of the separating wall remains on the one and/or the other side.

The generic turbine blade also has in the crown base at least one cooling-air opening which opens into the first and/or the second flow chamber and through which, consequently, cooling air is able to escape from the interior of the turbine blade to the free end. The cooling-air opening is in this case spaced apart from the wall sections, the precise position not being of primary importance according to the generic art.

According to the invention, the object is then achieved in that, instead of a further distribution of cooling-air openings over the surface of the crown base, at least one cooling-air opening is formed as a relief groove which is arranged above the first through-passage.

According to the invention, two embodiments come into consideration in the realization, wherein in a first embodiment according to the invention, use is made of a single relief groove. In a second embodiment according to the invention, it is in contrast provided that use is made of at least two relief grooves which, in this case, are to be arranged next to one another in an offset manner above the first through-passage.

Here, the one relief groove or the relief grooves in combination has/have at least a minimum length which corresponds to half the width of the separating wall. The introduction of a relief groove having a minimum length at least corresponding to half the width of the separating wall makes possible thermally induced material expansion in the upper region of the crown base in the region of the relief groove without the high thermal stresses owing to the temperature differences, which stresses otherwise arise, directly occurring.

In this case, the width of the separating wall is measured as the spacing between the pressure-side wall section and the suction-side wall section at the end of the separating wall beneath the crown base (if the first through-passage does not extend over the entire width) or adjacent to the first through-passage (if the first through-passage extends over the entire width).

The length of the relief groove can be defined in two ways. On the one hand, the direct length can be measured from one end of the relief groove to the other end of the relief groove independently of the form of said groove, that is to say the length of a straight connecting line between the two ends of the respective relief groove. However, for the effectiveness of the reduction in thermally induced stresses, the form of the relief groove in comparison with the position of the separating wall should be taken into consideration. Consequently, on the other hand, the effective minimum length of the single relief groove or of the relief grooves in combination is measured in a direction transverse to the first separating wall. That is to say, the minimum length corresponds in this case to a perpendicular to the separating wall, which perpendicular on surfaces, in each case parallel to the first separating wall, through the respective end of the single relief groove or of the combined relief grooves. In the case of a single relief groove which is oriented to be substantially perpendicular to the first separating wall, the direct length thus corresponds to the minimum length. In the case of two or more relief grooves being present, this consideration with regard to the effective minimum length applies in the case of the combined consideration of the two or more relief grooves measured in a direction transverse to the first separating wall.

An essential factor for the generation of thermal stresses is the presence of the separating wall which, as a result of the cooling air, has a relatively low temperature and thus relatively low thermal expansion, while in contrast, owing to the high temperatures prevailing in the gas turbine, the outer side of the crown base is subjected to relatively high material expansion.

Furthermore, for the effective reduction of the thermally induced stresses, it is therefore necessary for the single relief groove to extend to beyond the first through-passage, and thus beyond the first separating wall situated therebelow, on both sides. In the case of two or more relief grooves, it is necessary for said grooves, considered in combination, to extend beyond the first separating wall on both sides analogously to the embodiment with a single relief groove.

In the case of at least two relief grooves, said grooves must overlap such that, in the region of the first separating wall, a break in the crown base is present above the first through-passage in the connection from the pressure-side wall section to the suction-side wall section. Here, as in the use of a single relief groove, the two or more relief grooves are likewise to be arranged such that, when considered in combination, they extend beyond the through-passage on both sides. Furthermore here, it is necessary for each of the at least two relief grooves to extend at least to the through-passage.

Irrespective of the first or second embodiment, however, it is unimportant whether, in addition to the single relief groove or the considered relief grooves, further groove-like cooling-air openings are present in the crown base.

Furthermore, at least one second separating wall and a third flow chamber are present. In this case, the second separating wall is also adjacent to the second flow chamber and is situated opposite the first separating wall in the connection of the pressure-side wall section to the suction-side wall section. A second free through-passage is likewise situated above the second separating wall. A third flow chamber is situated adjacent to the second separating wall and opposite the second flow chamber, with cooling air being able to flow from the third flow chamber to the second flow chamber through the second through-passage.

In this case, the third flow chamber is advantageously adjacent to an inflow-side edge of the blade airfoil, or to a front edge which, opposite the rear edge, connects the pressure-side wall section to the suction-side wall section.

The size of the second through-passage is not of primary importance, with this advantageously being at least double the size of the first through-passage. That is to say the free cross section of the first through-passage is at most 0.5 times the free cross section of the second through-passage. It is particularly advantageous, however, if the second through-passage is at least 5 times the size of the first through-passage. In this case, it is possible both for the second through-passage to have a smaller width in relation to the width of the second separating wall and for the second through-passage to advantageously extend over the width of the second separating wall and accordingly upwardly delimit the latter on the side pointing toward the crown base.

In order to compensate for thermal deformations for the purpose of avoiding impermissibly high thermal stresses, it is furthermore advantageous if the single relief groove or the two or more relief grooves is/are situated in the crown base substantially centrally between the suction-side wall section and the pressure-side wall section. The precise position is unimportant, however, if thermally induced expansion of the top side of the crown base is possible on both sides owing to the relief groove or the relief grooves.

It is likewise advantageous if the single relief groove or, in the alternative embodiment, the two or more relief grooves are situated substantially centrally in relation to the separating wall. Since the first separating wall, in particular, is partially responsible for the thermal stresses in the crown base, it is correspondingly advantageous to arrange the relief groove or the relief grooves centrally in relation to said first separating wall. If the length of the relief groove is lengthened beyond the required dimension, it is then in contrast of secondary significance whether the lengthening occurs on one side only from the separating wall.

The specific orientation of the relief groove or the multiple relief grooves is not of primary importance as long as, owing to the presence of the relief groove, a corresponding thermal expansion of the crown base on the outwardly pointing side becomes possible. In this case, however, when using a single relief groove, it is particularly advantageous if the relief groove extends substantially transversely to the first separating wall. A rectilinearly right-angled orientation is not necessary in this case, but rather it is sufficient if the relief groove runs according to the profile of the pressure-side wall section and of the suction-side wall section. In this respect, for example angle deviations of 15° from an orientation perpendicular to the separating wall are unimportant.

Furthermore, in the case of an arrangement of at least two relief grooves connected to the through-passage, it is advantageous for said grooves to each be arranged at an angle in relation to a perpendicular to the separating wall. An arrangement in a substantially mutually parallel manner and in a manner offset in the longitudinal direction of the relief grooves thus has a favorable effect. Nevertheless, the angle deviation in relation to an orientation perpendicular to the separating wall should, where possible, be not more than 45°, particularly advantageously not more than 30°.

The effectiveness of the relief groove is particularly advantageously improved if the single relief groove has an effective minimum length corresponding to the width of the separating wall, that is to say the minimum length corresponds to at least the width of the first separating wall.

Since the web present between the relief grooves in the crown base brings about a particular stiffening, it is particularly advantageous in this second embodiment if each of the relief grooves has a length of at least 0.3 times the width of the first separating wall. Particularly advantageously, the length of the respective relief grooves is at least 0.5 times the width of first separating wall.

It is furthermore advantageous if the minimum length of the at least two relief grooves in combination corresponds to at least 0.7 times the width of the first separating wall. In this second embodiment, it is particularly advantageous if the relief grooves in combination have a minimum length of at least the width, advantageously 1.2 times the width, of the first separating wall.

It is furthermore advantageous if the first through-passage is used primarily for relieving the stresses in the crown base and secondarily for guiding cooling air. In this case, it is particularly advantageous if the height of the first through-passage, measured from the inwardly pointing bottom side of the crown base to the maximum spacing of the first through-passage to the crown base, corresponds to at most 2 times the thickness of the crown base.

For allowing the thermally induced expansions in the crown base, it is in any case particularly advantageous if the height (as defined above) of the first through-passage corresponds to at least 0.5 times the thickness of the crown base.

Cooling air guidance through the relief groove or the relief grooves and at the same time an—in particular multiply—diverted flow inside the blade airfoil through the first and the second flow chamber is promoted if the first through-passage is advantageously not selected to be excessively large. Therefore, the first through-passage advantageously has a free cross section (area size of the first through-passage as considered in a plane of the first separating wall) which corresponds to at most 0.8 times the minimum free cross section (considered in a surface parallel to the top side of the crown base) of the single relief groove in the first embodiment or the at least two relief grooves in combination in the second embodiment.

Here, however, the free cross section of the first through-passage should advantageously correspond to at least 0.2 times the free cross section of the relief groove or the relief grooves.

The profile of the relief groove or the relief grooves is not of primary importance, with a rectilinear profile being selected in an extremely simple manner. Alternatively, it is also possible for that side surface of the relief groove or of the relief grooves which faces the pressure-side wall section to have an arcuate profile corresponding to the curvature of the pressure-side wall section. Analogously, it is possible for that side surface of the relief groove or of the relief grooves which faces the suction-side wall section to have an arcuate profile corresponding to the curvature of the suction-side wall section. Accordingly, the relief groove follows the profile of the pressure-side or suction-side wall section.

With regard to the use of the cooling air exiting the relief groove and in consideration of the cooling air flow, from the second flow chamber to the first flow chamber, prevailing in the blade airfoil, it is furthermore advantageous for the relief groove to be formed so as to be at an angle. For this purpose, it is advantageous for that end of the relief groove which points away from the blade root, that is to say that end of the relief groove which points toward the outer side, to be located closer to the pressure-side wall section than that end of the relief groove which points toward the blade root, that is to say that end of the relief groove which is adjacent to the through-passage.

Furthermore, for the purpose of restricting the flow in the relief groove and in consideration of the production possibilities, it is advantageous for the one relief groove or at least one of the two or more relief grooves to widen from a minimum free cross section toward one end or toward both ends of the respective relief groove. Accordingly, the flow from the first flow chamber is restricted by way of the minimum free cross section, wherein, as a result of the widening of the relief groove, the production thereof is simplified.

Particularly advantageously, the relief groove according to the invention is used in a separating wall in the case of which the first flow chamber is arranged at an outflow-side edge, or rear edge, of the blade airfoil. The rear edge adjacent to the first flow chamber connects the pressure-side wall section to the suction-side wall section. In this respect, it is unimportant whether elements for flow guidance and/or stiffening of the blade airfoil, which elements point toward the outflow-side edge, are present in the first flow chamber.

Particularly advantageously, the cooling air flowing through the turbine blade is guided substantially through the second through-passage but only to a small extent through the first through-passage. For this purpose, the first through-passage has a free cross section of at most 0.1 times the free cross section of the second through-passage.

If a first separating wall and a second separating wall are used for subdividing the cavity present in the blade airfoil into a first flow chamber, a second flow chamber and a third flow chamber, it is particularly advantageous for the first flow chamber and the first separating wall to be arranged on that side which faces the outflow-side edge, and for the third flow chamber and the second separating wall to be arranged on that side which faces the inflow-side edge, of the blade airfoil.

It is furthermore advantageous for a free third through-passage to be present at that end of the first separating wall which points toward the blade root, so that the cooling air is able to flow from the third flow chamber into the second flow chamber via the second through-passage, and into the first flow chamber partially via the first through-passage and mainly via the third through-passage.

With regard to the arrangement of the crown base on the blade wall, there are various possibilities available. In a first and simple embodiment, the crown base is situated precisely at the end of the blade wall and thus forms the end of the blade airfoil. By contrast, it is however advantageous if the crown base is set back in relation to the end of the blade wall and, accordingly, the pressure-side wall section and/or the suction-side wall section projects beyond the crown base at least in sections. In a further alternative, it is also possible to arrange the crown base at the end of the blade wall, in this case however providing further ribs or webs or the like above the crown base.

Furthermore, a coating is advantageously applied to the crown base. In this case, on the one hand, it may be provided that a coating is applied before the relief groove is created. On the other hand, it is advantageous for a coating to be applied to the crown base provided with the relief groove. The second variant offers the particular advantage that the coating is, at least partially, able to be applied to the outside ends of the side surfaces of the relief groove, as a result of which the gap width thereof is reduced. This allows the cooling air flow through the relief groove to be reduced, with the desired free space for expansion being maintained to a sufficient degree.

### BRIEF DESCRIPTION OF THE DRAWINGS

An exemplary turbine blade with relief grooves which are sketched by way of example is shown in the following figures.

In the figures:

FIG. 1 shows a turbine blade for one example of the invention;

FIG. 2 shows a section through the blade airfoil centrally between the pressure-side and the suction-side wall section;

FIG. 3 shows a plan view of the blade airfoil with a first exemplary embodiment of a relief groove;

FIG. 4 shows a plan view of the blade airfoil with an alternative arrangement of relief grooves;

FIG. 5 shows a section through the blade airfoil, parallel to the first separating wall, with an obliquely positioned relief groove;

FIG. 6 shows a section analogous to FIG. 5 with a widening relief groove.

### DETAILED DESCRIPTION OF INVENTION

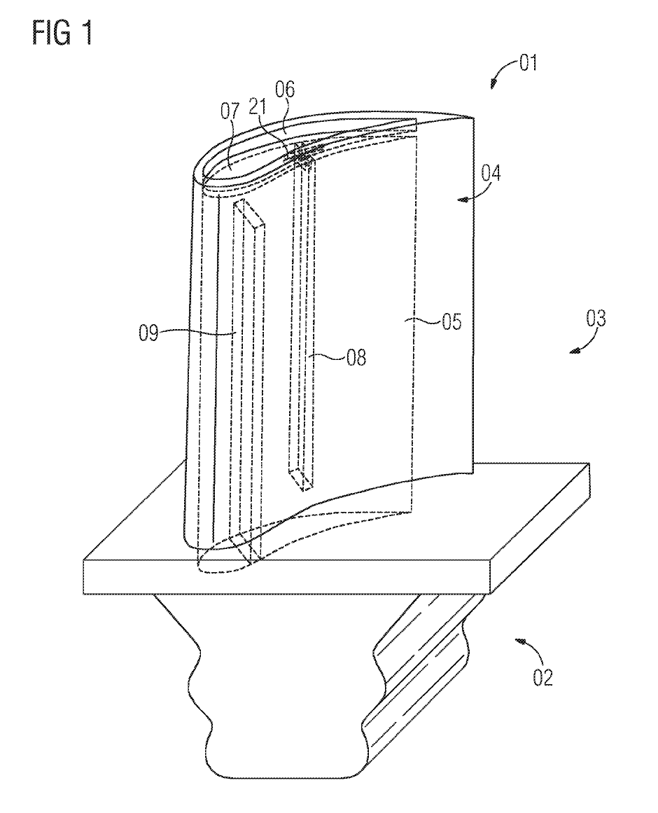

FIG. 1 shows by way of example a turbine blade 01 having a blade root 02 and having a blade airfoil 03 adjoined to the blade root. The embodiment of the blade root 02 is unimportant for the present invention, and accordingly a more detailed discussion in this regard will not be given. The blade airfoil 03 comprises first of all the blade wall 04, which 04, in this exemplary embodiment, is formed by a pressure-side wall section 05 (situated at the front in the plane of the drawing) and a suction-side wall section 06 (situated at the rear in the plane of the drawing), which 05, 06 both extend from a front edge to a rear edge. In this case, the blade wall 04 encloses a cavity which is in turn formed by flow chambers 11, 12, 13. Situated at the free end of the blade airfoil 03 is the crown base 07, which 07, in this exemplary embodiment, is set back slightly in relation to the end of the blade airfoil 03. Inside the blade airfoil 03, the cavity is subdivided by a first separating element 08 and a second separating element 09 into a first flow chamber 11 between the rear edge and the first separating wall 08 and into a second flow chamber 12 between the first separating wall 08 and the second separating wall 09 and into a third flow chamber 13 between the second separating wall 09 and the front edge. At the top side, the relief groove 21 in the crown base 07 can partially be seen.

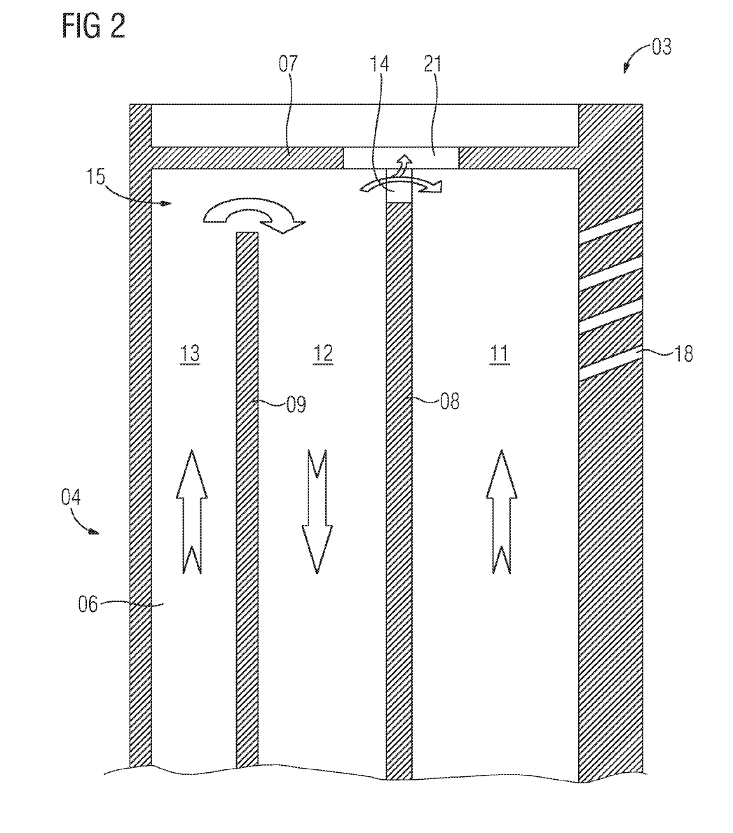

FIG. 2 then schematically shows a section through the blade airfoil 03 in a central section view between the pressure-side wall section 05 and the suction-side wall section 06. First of all, the blade wall 04 with the front edge and the rear edge can be seen. Situated at the top side is the crown base 07, which 07 is set back slightly in relation to the end of the blade wall 04. Situated inside the blade airfoil 03 are the first separating wall 08 and the second separating wall 09, which 08, 09 subdivide the cavity in the interior of the blade airfoil 04 into the first flow chamber 11, the second flow chamber 12 and the third flow chamber 13. In this exemplary example, it is provided that a cooling-air flow flows from the third flow chamber 13 into the second flow chamber 12, and subsequently into the first flow chamber 11. It is possible for the cooling air to escape via cooling-air bores 18 which are arranged in the blade wall 04 at the rear edge. For the realization of the crossover of the cooling air from the first flow chamber 11 to the second flow chamber 12, a second free through-passage 15 is situated between the second separating wall 09 and the crown base 07.

For the reduction according to the invention of the thermal stresses in the crown base 07, first of all there is also arranged in the first separating wall 15 a first free through-passage 14 at the end pointing toward the crown base 07. Furthermore, at least one relief groove 21 is situated in the crown base 07. This 21 extends here centrally over the through-passage 14 and thus allows thermal expansion of the top side of the crown base 07, with the pressure-side wall section 05 being simultaneously held to the suction-side wall section 06 by the first separating wall 08.

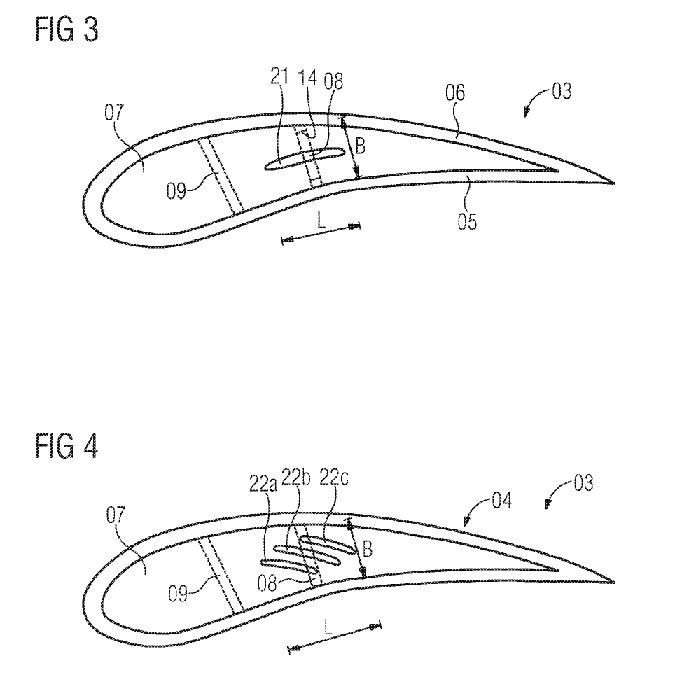

FIG. 3 then shows a plan view of the blade airfoil 03, wherein first of all the blade wall 04 with the pressure-side wall section 05 and the suction-side wall section 06 can again be seen. The first separating wall 08 and the second separating wall 09 are situated in the interior of the blade airfoil 03 beneath the crown base 07. The relief groove 21, which is arranged centrally in the crown base 07, is situated above the first separating wall 08. This 21 has a length L, measured transversely to the separating wall, in this exemplary embodiment, which L approximately corresponds to the width B of the separating wall.

In the subsequent FIG. 4, a plan view of the blade airfoil 03 is sketched in a further exemplary embodiment analogously to FIG. 3. In contrast to the previous exemplary embodiment, instead of a single relief groove 21, use is then made in the crown base 07 of three relief grooves 22a, 22b and 22c which run so as to be parallel and offset with respect to one another. These 22a, 22b, 22c likewise extend here beyond the first separating wall 08 and are in this case arranged centrally in relation to the first separating wall 08. The length L, measured transversely to the first separating wall 08, of the three relief grooves 22a, 22b and 22c considered in combination is in this case slightly larger than the width B of the first separating wall 08.

In the subsequent FIG. 5, the relief groove 21 is sketched by way of example in a section parallel to the separating wall 08. In contrast to a possible embodiment of the relief groove 21 which is rectilinear in a manner perpendicular to the crown base 07, the relief groove 21 is positioned obliquely in this exemplary embodiment. Here, the top-side, outwardly pointing end of the relief groove 21 is situated approximately centrally in the crown base 07 between the pressure-side wall section 05 and the suction-side wall section 06. On the side of the through-passage 14 above the first separating wall 08, however, the relief groove 21 is situated closer to the suction-side wall section.

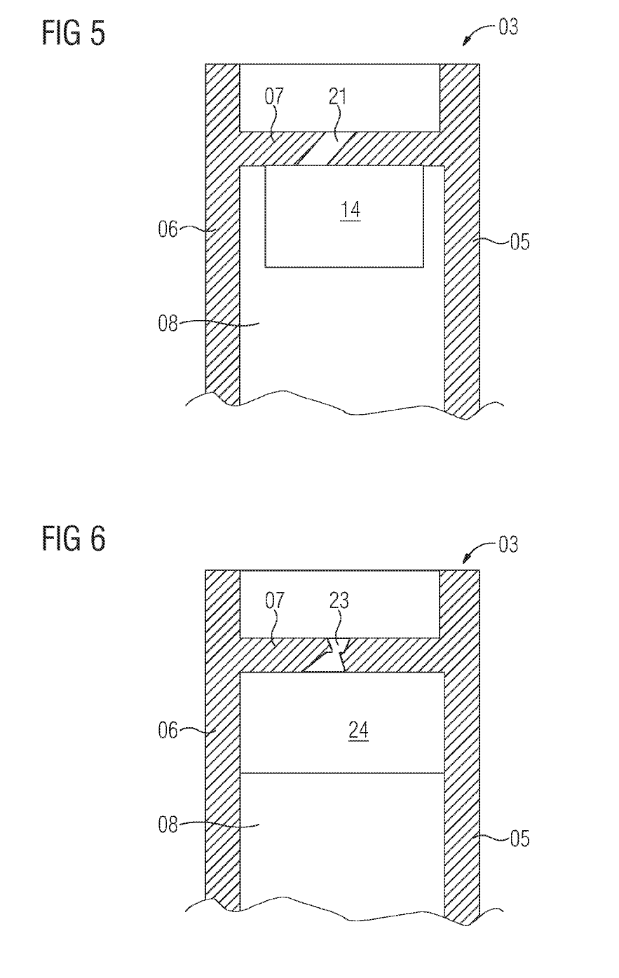

In FIG. 6, a further exemplary embodiment for a relief groove 23 is sketched, wherein the illustration is rendered analogously to FIG. 5. In this exemplary embodiment, the relief groove 23 has, centrally between the two ends of the relief groove, a minimum cross section from which the relief groove 23 widens in both directions, that is to say inwardly and outwardly. This not only allows the cooling air to be restricted but also simplifies the production of the relief groove 23.

1. A turbine blade for a gas turbine, comprising:
a blade root, and
an aerodynamically curved blade airfoil, which has a blade wall and has a crown base which is arranged at the free end of the blade airfoil,
wherein the blade wall comprises a pressure-side and a suction-side wall section and encloses at least one first and one second flow chamber, between which a first separating wall, which connects the wall sections, is arranged,
wherein the first separating wall has, at the end pointing toward the crown base, a through-passage for connecting the first flow chamber to the second flow chamber, and wherein at least one cooling-air opening is present in the crown base,
wherein the cooling-air opening being formed as a single relief groove (21,23), or being formed by at least two relief grooves (22a,22b,22c) which are arranged next to one another in an offset manner, the individual or combined minimum length (L) of which relief grooves (21,22a,22b,22c,23) corresponds to at least 0.5 times the width (B) of the first separating wall and which relief grooves (21,22a,22b,22c,23), on both sides, extends/extend individually or in combination to beyond the through-passage,
wherein a second separating wall is arranged adjacent to the second flow chamber and a third flow chamber is arranged opposite the first flow chamber, and
wherein a second through-passage is present between the second separating wall and the crown base, which has at least 2 times, in particular at least 5 times or in particular at least 10 times, the free cross section of the first through-passage.

2. The turbine blade as claimed in claim 1,
wherein the relief groove (21,23) or the relief grooves (22a,22b,22c) in combination is/are arranged centrally between the wall sections and/or centrally with respect to the first separating wall.

3. The turbine blade as claimed in claim 1,
wherein the relief groove (21,23) or the relief grooves (22a,22b,22c) in combination has/have at least a minimum length (L), measured transversely to the separating wall, corresponding to the width (B) of the separating wall,
wherein in particular the relief grooves (22a,22b,22c) each have a length of at least 0.3 times the width (B) of the first separating wall.

4. The turbine blade as claimed in claim 1,
wherein the height of the first through-passage perpendicular to the crown base corresponds to at least 0.5 times and/or at most 2 times the thickness of the crown base.

5. The turbine blade as claimed in claim 1,
wherein the free cross section of the first through-passage is at least 0.2 times and/or at most 0.8 times the minimum free cross section of the relief groove (21,23) or of the relief grooves (22a,22b,22c) in combination.

6. The turbine blade as claimed in claim 1,
wherein those side surfaces of the relief groove (21,23) or of the relief grooves (22a,22b,22c) which face the wall sections have a rectilinear profile, or an arcuate profile corresponding to the curvature of the respective wall section.

7. The turbine blade as claimed in claim 1,
wherein the first flow chamber is arranged adjacent to an outflow-side edge of the blade airfoil.

8. (canceled)

9. (canceled)

10. The turbine blade as claimed in claim 1,
wherein the first separating wall is arranged facing the outflow-side edge, and the second separating wall is arranged facing the inflow-side edge, of the blade airfoil.

11. The turbine blade as claimed in claim 1,
wherein the pressure-side and/or the suction-side wall section, in particular the blade wall, projects beyond the crown base at least in sections.
